(19) United States
(12) Patent Application Publication
(10) Pub. No.: US 2006/0074170 A1
(43) Pub. Date: Apr. 6, 2006

(54) Thermoplastic elastomer, composition, gasket, molded gasket and structure for sealing between two members

(75) Inventors: Yoshifumi Kojima, Fujisawa-shi, Kanagawa (JP); Atsushi Koga, Fujisawa-shi, Kanagawa (JP); Kenichi Fujimoto, Fujisawa-shi, Kanagawa (JP); Kazuhisa Senda, Fujisawa-shi, Kanagawa (JP)

Correspondence Address: JACOBSON HOLMAN PLLC, 400 SEVENTH STREET N.W., SUITE 600, WASHINGTON, DC, 20004, US

(73) Assignee: NOK CORPOATION, MINATO-KU TOKYO (JP)

(21) Appl. No.: 10/537,918

(22) PCT Filed: Oct. 30, 2003
(86) PCT No.: PCT/JP03/13922

§ 371 Date: Jun. 8, 2005

(51) Int. Cl. C08K 5/01

(52) U.S. Cl. 524/474

(57) ABSTRACT

According to the present invention, provided is a thermoplastic elastomer composition, comprising an ethylene-propylene-nonconjugated diene ternary copolymer or an ethylene-propylene binary copolymer, a crystalline polyolefin resin, a non-aromatic softening agent, and an organic peroxide, in which the crystalline polyolefin resin has from 0.1 g/10 min. to 100 g/10 min. of melt flow rate which is measured in accordance with JIS K7210 under conditions of 230° C. and 21.18 N and is contained in an amount of from 10 to 150 parts by weight every 100 parts by weight of the copolymer; the non-aromatic softening agent has a kinetic viscosity of 300 mm²/s or more at 40° C. and is contained in an amount of from 20 to 150 parts by weight every 100 parts by weight of the copolymer; the organic peroxide is contained in an amount of from 0.1 to 10 parts by weight every 100 parts by weight of the copolymer; and hardness measured by a JIS type A durometer is from 30 to 70 degrees. According to the present invention provided are a thermoplastic elastomer composition, a gasket, a molded gasket, and a sealing structure between two members, in which a quality such as sealability has been improved, and, further, provided are a molded gasket, and a sealing structure between two members, in which a production process has been simplified.

### TECHNICAL FIELD

Present invention relates to a thermoplastic elastomer, a gasket, a molded gasket and a sealing structure between two members.

### BACKGROUND ART

Conventionally, a gasket has been used as a sealing member for sealing a space between a main body and a cover of a casing which constitute a frame of each of electronic devices, for example, a hard disk drive of a computer.

FIG. 4 is a schematic diagram showing a main body and a cover of a casing of a hard disk drive to which this type of gasket is attached in a manner separate from each other.

As shown in FIG. 4, a frame of the hard disk drive 101 comprises a cuboid casing main body 110 deprived of a top face, a cover 120 constituting the top face of the casing main body 110, and a gasket (sealing member in an endless state) 130 which is interposed between the casing main body 110 and the cover 120 to seal a space between the two members 110 and 120.

In recent years, along with a trend of down-sizing and higher performance of electronic devices, it is required to allow sizes and thickness of components thereof to be smaller. When the components become smaller in size, since assembling workability in a production process is deteriorated, it is required to integrate various types of components or allow them to be a composite. At the same time, enhancements of performances of required characteristics (outgassing property, sealability, and quality) are required.

The gasket for an electronic memory device, particularly, hard disk drive, is attached such that a rubber singular body, or a foamed polyurethane sheet is inserted in a metallic cover made of, for example, stainless steel or aluminum. Since attaching work is favorably performed by integrating a rubber material (mainly, fluorocarbon rubber) into the metallic cover made of, for example, stainless steel, it has been proposed to bond rubber to a metal by using an adhesive (Japanese Patent No. 2517797).

However, in a method described in the above patent, the rubber in a gasket shape is previously vulcanize-molded in a separate step and, then, bonded to the metallic cover by using the adhesive. This method is long in production process and complicated. Actually, a vulcanizing step required several minutes and, since the gasket after being vulcanized was thin and liable to be broken and, also, apt to catch dirt or the like, it was necessary to perform rinsing several times or conduct a selection work before assembling.

On the other hand, a gasket material comprising a styrene-type elastomer has been proposed (Japanese Patent No. 2961068), in which it is shown that a process can be simpler than that of the rubber material because it is not necessary to perform a vulcanizing step and a cost reduction can be realized because the material can be recycled.

In a technique as described in this patent, unless the gasket which is thin, soft, and liable to be adhered is previously fixed by one measure or another, workability becomes extremely inferior at the time of actually assembling the hard disk drive.

In this technique, as a countermeasure, a gasket comprising a styrene-type elastomer is previously formed on an article called as a frame by injection molding and, then, the thus-formed gasket is attached to between a casing such as a hard disc drive and a cover to be integrated thereamong; however, after all, a third article called as the frame comes to be required.

Further, in recent years, the gasket tends to be exposed to heat generated along with a higher performance (higher revolutions) of the hard disk drive or in a using environment of higher temperature (particularly, 80° C. or more) by being adopted as an in-vehicle article.

In these cases, it can be said that performance of a conventional styrene-type elastomer has reached the limit thereof.

Namely, when the gasket is clamped for a long period of time under a high temperature, sealability comes to be insufficient due to a permanent deformation thereof.

### DISCLOSURE OF THE INVENTION

The present invention has been achieved to solve these problems of conventional techniques and has an object to provide a thermoplastic elastomer composition, a gasket, a molded gasket, and a sealing structure between two members in which a quality such as sealability has been improved, and, further, to provide a molded gasket and a sealing structure between two members in which a production process has been simplified.

In order to attain the aforementioned object, in the present invention, a thermoplastic elastomer composition, comprising an ethylene-propylene-nonconjugated diene ternary copolymer or an ethylene-propylene binary copolymer, a crystalline polyolefin resin, a non-aromatic softening agent, and an organic peroxide, is characterized in that the crystalline polyolefin resin has from 0.1 g/10 min. to 100 g/10 min. of melt flow rate which is measured in accordance with JIS K7210 under conditions of 230° C. and 21.18 N and is contained in an amount of from 10 to 150 parts by weight every 100 parts by weight of the copolymer;

the non-aromatic softening agent has a kinetic viscosity of 300 mm²/s or more at 40° C. and is contained in an amount of from 20 to 150 parts by weight every 100 parts by weight of the copolymer;

the organic peroxide is contained in an amount of from 0.1 to 10 parts by weight every 100 parts by weight of the copolymer; and

hardness measured by a JIS type A durometer is from 30 to 70 degrees.

Preferably, the crystalline polyolefin resin is contained in an amount of 100 parts by weight every 100 parts by weight of the copolymer.

Preferably, compression set measured in accordance with JIS K6262 after 168 hours of standing time at 100° C. is 50% or less.

A gasket is characterized by being formed by using the aforementioned thermoplastic elastomer composition as a material.

A molded gasket constituting a cover member is characterized in that the aforementioned thermoplastic elastomer composition is integrally molded together with a metal sheet as a gasket.

A sealing structure between two members constituted such that a metal surface of one member and a surface of the other member face to each other while interposing a gasket therebetween is characterized by being constituted such that the gasket which is formed by injection molding the aforementioned thermoplastic elastomer composition on a metal surface of one member coated with an adhesive is pressed against a surface of the other member.

A gasket, which is interposed between a surface of a first member and a surface of a second member that face to each other and is adhered to the surface of the first member such that it seals a space between the two members, is characterized in that, as a cross-sectional shape of the gasket in a width direction, length H0 in a direction in which the two members face to each other and width W0 of an adhesion face against the surface of the first member have a relation of “H0/W0≧0.8” therebetween and, further, as a cross-sectional shape of the gasket in the width direction, a base portion arranged on the side of the surface of the first member and a projection portion which is formed in a state projected from the base portion and comprises a tip end of a curved face pointing toward the surface of the second member are provided and, still further, a curvature radius R of the tip end of the curved face is 0.1 mm or more.

Furthermore, the aforementioned constitutions may be combined thereamong as far as possible.

### BRIEF DESCRIPTION OF THE DRAWINGS

FIG. 1 is an exploded perspective diagram of a casing constituting a frame of a hard disk drive in which a gasket is applied according to an embodiment of the present invention;

FIG. 2 is a cross-sectional diagram showing a cross-section of a gasket according to each of various embodiments of the present invention and a comparative example;

FIG. 3 is a cross-sectional diagram showing a cross-sectional shape of a gasket according to an embodiment of the present invention; and

FIG. 4 is an exploded perspective diagram of a casing constituting a frame of a hard disk drive.

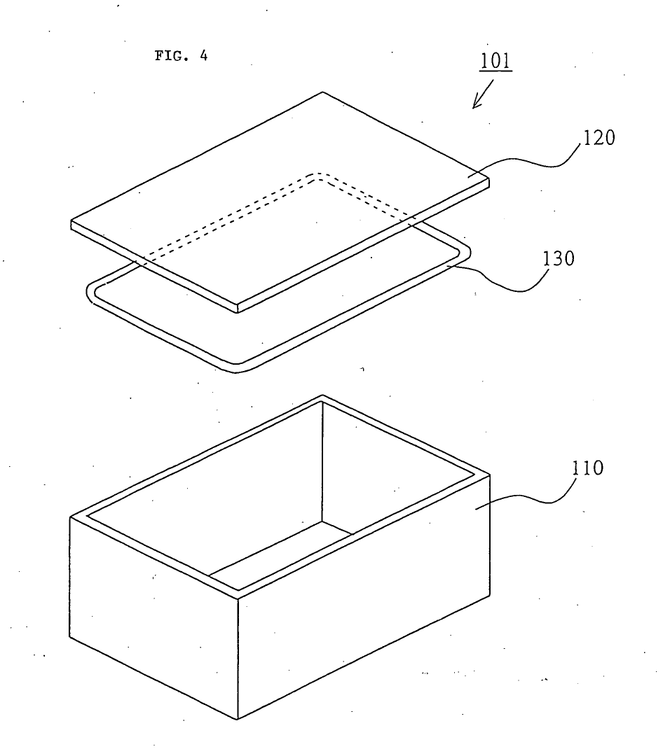

### DESCRIPTION OF REFERENCE NUMERALS AND SIGNS

1, 101 Hard disk drive (casing)
10, 110 Casing main body
20, 120 Cover
30, 130 Gasket
31 Base end face
32 Tip end face
33 Base portion
34 Projection portion
R Curvature radius
H0 Length of gasket in a cross-sectional state
H1 Length of gasket in a cross-sectional state when being compressed
W0 Width of adhesion face
W1 Width of intermediate portion

### BEST MODE FOR CARRYING OUT THE INVENTION

The present inventors have studied for obtaining a molded gasket which does not need such a third member as described in Japanese Patent No. 2961068 and is capable of attaining improvements of quality such as an improvement of high temperature performance, simplification of a production process (facilitation of production), an improvement of sealability, and an improvement of an outgassing property. As a result, the present inventors have found that a production can be easily performed by allowing an adhesive to be contained between a metal sheet and a gasket, allowing a gasket to comprise a specified thermoplastic elastomer composition, and performing integral molding by means of injection molding while a metal sheet coated with an adhesive being inserted. Further, the present inventors have found that compression set is improved by allowing the thermoplastic elastomer composition to be partially cross-linked and, accordingly, sealability and the like under a high temperature is improved.

Still further, it has been found that, depending on a gasket having a specific constitution, when the gasket is in a using state, a projection portion is pressed against a surface of a second member and, accordingly, the gasket is compressed in a highly reproducible and comparatively constant shape and, therefore, a large reaction force against the surface of the second member is generated; hence, a sufficient sealability between a surface of a first member and the surface of the second member is secured for a long period of time.

Hereinafter, a constitution of an integrated gasket with a cover for a hard disk drive (hereinafter also referred to simply as “cover”) as a molded gasket according to an embodiment of the present invention is described.

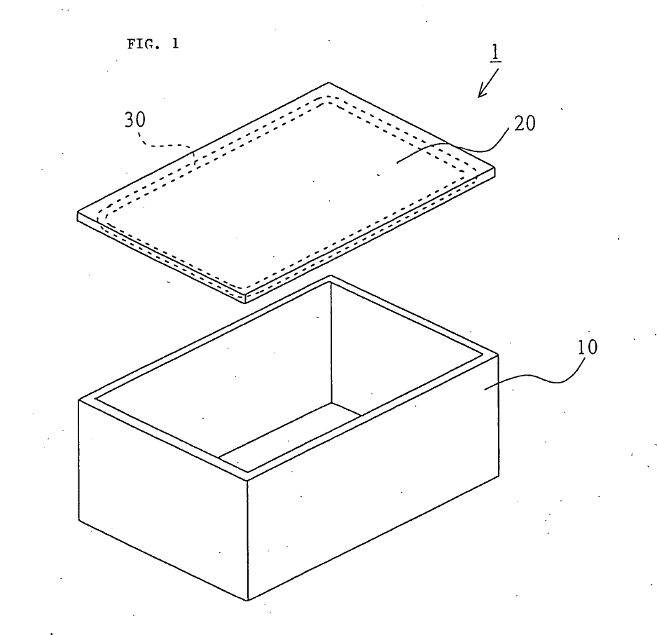

FIG. 1 is a schematic diagram showing a state in which a casing main body and a cover of a hard disk drive to which a gasket according to the present embodiment is attached are separated from each other.

In a same manner as in a previous conventional technique, a frame of the hard disk drive 1 according to the present embodiment comprises a cuboid casing main body 10 deprived of a top face, a cover 20 constituting the top face of the casing main body 10. As for the cover 20, a metal sheet, such as an aluminum sheet, a plated aluminum sheet, a stainless steel sheet or a laminated damping steel sheet made of stainless steel is used. On a rear face (face on the side facing to casing main body 10) of the cover 20, a gasket (endless sealing member) 30 which is interposed between the casing main body 10 and the cover 20 and seals a space between the two members 10 and 20 is adhered in assembling the case.

The gasket 30 is composed of a thermoplastic elastomer composition, which comprises,
a material A: an ethylene-propylene-nonconjugated diene ternary copolymer or an ethylene-propylene binary copolymer;
a material B: a crystalline polyolefin resin having a melt flow rate (MFR) (in accordance with JIS K7210; 230° C., 2.16 kg load (21.18 N)) of from 0.1 g/10 min. to 100 g/10 min;
a material C: a non-aromatic softening agent having a kinetic viscosity at 40° C. of 300 mm²/S or more; and
a material D: an organic peroxide and which contains, based on 100 parts by weight of the material A, from 10 to 150 parts by weight, preferably 100 parts by weight of the material B,

from 20 to 150 parts by weight of the material C, and

from 0.1 to 10 parts by weight of the material D, and which is partially cross-linked and is adjusted to have a hardness of from 30 to 70 degrees (in accordance with JIS K6253; type A durometer) .

On the rear face of the cover 20, a liquid adhesive based on a modified olefin resin or a styrene-butadiene rubber is applied and, then, a composition which becomes a material for the gasket 30 is injection molded on the face thus-applied with the adhesive and, as a result, the cover 20 and the gasket 30 are instantaneously integrally molded.

Next, each of materials constituting the thermoplastic elastomer composition according to the present embodiment is described. (Copolymer (hereinafter referred to also as “copolymer rubber”))

As for copolymers, mentioned is an ethylene-propylene-nonconjugated diene ternary copolymer or an ethylene-propylene binary copolymer.

The ethylene-propylene-nonconjugated diene ternary copolymer refers to a copolymer obtained by copolymerizing monomers of ethylene, propylene, and a nonconjugated diene thereamong, or a copolymer obtained by copolymerizing an ethylene-propylene binary copolymer and a nonconjugated diene therebetween. As for the ethylene-propylene-nonconjugated diene ternary copolymer rubber, it is preferable that an ethylene content thereof is in the range of from 50 to 80% by weight and an iodine number thereof is in the range of from 10 to 25.

As for the ethylene-propylene binary copolymer rubber, it is preferable that an ethylene content thereof is in the range of from 10 to 25% by weight and MFR thereof is in the range of from 3 g/10 min. to 30 g/10 min.

In this case, as for the nonconjugated diene, dicyclopentadiene, 1,4-hexadiene, dicyclooctadiene, methylene norbornene, ethylidene norbornene or the like is used.

As for the ethylene-propylene-nonconjugated dience ternary copolymer rubber, practically, various types of EPDM which are available in the market can be used.

(Crystalline Polyolefin Resin)

As for the crystalline polyolefin resin, a polypropylene-type resin is preferable. The polypropylene-type resin, which is a thermoplastic resin obtained by polymerizing propylene in the presence of a catalyst, is a crystalline polymer having, for example, an isotactic or a syndiotactic structure or a copolymer of the crystalline polymer and a small amount of an α-olefin (for example, ethylene, 1-butene, 1-hexene, or 4-methyl-1-pentene).

Among such copolymers, a copolymer in which the MFR (in accordance with JIS K7210; 230° C.; and 2.16 kg load (21.18 N)) is from 0.1 g/10 min. to 100 g/10 min. and the crystallinity is from 20 to 70% is preferable.

On this occasion, when the MFR is unduly smaller than 0.1, flowability is deteriorated and, accordingly, a targeted moldability can not be obtained. Whereas, when the MFR is unduly larger than 100, a sufficient physical property cannot be obtained.

Further, in order to obtain a desired moldability or hardness, a polypropylene-type resin is indispensable. However, when the polypropylene-type resin is unduly large in amount, the hardness becomes high while, when the polypropylene-type resin is unduly small in amount, the flowability becomes deteriorated and, accordingly, it becomes difficult to perform injection molding.

Therefore, it is preferable that the crystalline polyolefin resin is contained in an amount of from 10 to 150 parts by weight every 100 parts by weight of the copolymer.

(Softening Agent)

As for the softening agent, a softening agent which is used in an ordinary rubber or thermoplastic elastomer is permissible so long as it is a non-aromatic softening agent having a kinetic viscosity at 40° C. of 300 m²/s or more. Examples of such softening agents include petroleumoil-type softening agents such as process oil, a lubricant and paraffin-type oil; and fatty oil-type softening agents such as castor oil, linseed oil, rapeseed oil, and cocoanut oil.

Further, when the kinetic viscosity of the softening agent is unduly low (100 mm²/s or less) , a material having a low molecular weight becomes large in amount which comes to be detected as an outgas.

Still further, when the softening agent is unduly large in amount, outgassing becomes large while, when it is unduly small in amount, it can not be adjusted to have a desired hardness; these cases are not favorable. A preferable amount of the softening agent is from 10 to 200 parts by weight.

(Organic Peroxide)

As for cross-linking agents, organic peroxides are primarily favorable. Examples of the organic peroxides include dicumyl peroxide, di-tert-butyl peroxide, 2,5-dimethyl-2,5-di(tert-butylperoxy)hexane benzoyl peroxide, cumyl peroxide, 1,3-di(tert-butylperoxy)isopropylbenzene, 2,5-dimethyl-2,5-di (tert-butylperoxy)hexane, m-toleyl peroxide, dipropyonyl peroxide. The organic peroxides are each used in the range of approximately from 0.1 to 10 parts by weight and, preferably, approximately from 0.5 to 8 parts by weight every 100 parts by weight of the copolymer rubber.

Further, when it becomes unduly larger than 10 parts by weight in amount, cross-linking becomes tight and, accordingly, elasticity (mainly, elongation) as the elastomer becomes small and, as a result, a function as a gasket is impaired. Still further, when it is unduly smaller than 0.1 part by weight in amount, the cross-linking is scarcely performed and, accordingly, compression set becomes large, namely, sealability becomes deteriorated.

And, in the thermoplastic elastomer composition containing the aforementioned constituents according to the present embodiment, hardness measured by a type A durometer in accordance with JIS K6253 is adjusted to be from 30 to 70 degrees.

When the hardness is unduly larger than 70 degrees, a reaction force at the time of attaching the cover-integrated gasket into the main body becomes large and, accordingly, a cover deformation or the like is generated and, as a result, sealing can not be fully performed; hence, sealability as a gasket is inferior.

On the other hand, when the hardness becomes unduly smaller than 30 degrees, the outgassing becomes large. Further, it becomes necessary to pay attention to handling because it is likely to be broken or easy to be adhered. The most preferable hardness is from 40 to 60 degrees.

Still further, the hardness can be adjusted by changing an amount of the crystalline polyolefin resin to be compounded, or an amount of the non-aromatic softening agent to be compounded. Basically, the gasket can be harder by increasing the amount of the crystalline polyolefin resin to be compounded, while it can be softer by increasing the non-aromatic softening agent to be compounded and, therefore, by taking a well-balance between the aforementioned two incidents, a desired hardness can appropriately be adjusted.

In the composition according to the present embodiment, a scaly inorganic filler which is compounded in an ordinary rubber or thermoplastic elastomer, specifically, clay, diatomaceous earth, talc, barium sulfate, calcium carbonate, magnesium carbonate, a metal oxide, mica, graphite, or aluminum hydroxide can be used.

Further, a solid filler in powder form, for example, any of various types of metal powder, glass powder, ceramic powder, granulated or pulverized polymer; an antiaging agent such as an amine or a derivative thereof, any of imidazoles, any of phenols or derivatives thereof; and any of waxes can be used in a range which does not impair the performance.

Further, various types of additives, such as a stabilizer, an adhesion enhancer, a parting agent, a pigment, a flame-retardant, or a lubricant can be added. Still further, in order to improve abrasion resistance, moldability or the like, a small amount of thermoplastic resin or rubber can be added. Furthermore, in order to improve strength or rigidity, a short fiber or the like can be added in a range which does not impair the performance.

The cross-linking method of the thermoplastic elastomer composition according to the present embodiment is not particularly limited and known methods can be used. Among these methods, a kinetic cross-linking method is preferably used in view of efficiency.

The production method of the thermoplastic elastomer composition according to the present embodiment is not particularly limited and the thermoplastic elastomer composition can be produced by a known method.

The thermoplastic elastomer composition can easily be produced by performing melt-kneading by means of, for example, a heat-kneader, such as a single-screw extruder, a twin-screw extruder, a roll, a Bumbury's mixer, a brabender, a kneader, or a high shearing-type mixer and, then, by adding a cross-linking agent such as an organic peroxide, a cross-linking auxiliary, or the like while simultaneously mixing these necessary components and, thereafter, by heat-melt-kneading.

Further, a thermoplastic material in which a polymeric organic material and a softening agent are kneaded is previously prepared and, then, the thus-prepared material is added to at least one polymeric organic material which is same with or different from that used in the above to thereby produce the thermoplastic elastomer composition.

The thus-produced thermoplastic elastomer composition is molded into a desired shape by a known method, such as injection molding or extrusion molding and, then, the resultant mold can be used as a gasket.

Next, the metal sheet is explained.

In the present embodiment, it is favorable that, as the metal sheet, an aluminum sheet or a plated aluminum sheet, a stainless steel sheet or a laminated damping steel sheet made of stainless steel is used. Any one these sheet is used such as a cover for hard disk drive. Further, the metal sheet is not limited to these metal sheets and may appropriately be determined depending on specifications of products.

Still further, the molded gasket according to the present embodiment is an integrally molded product of the gasket produced from the aforementioned thermoplastic elastomer composition, and the metal sheet.

Particularly, the metal sheet is coated with an adhesive which is based on a modified olefin-type resin and made into a liquid state or based on styrene-butadiene rubber and made into a liquid state and, then, inserted into a mold and, thereafter, injection molded to thereby allow the gasket and the metal sheet to be surely and instantaneously integrated. In a case in which the adhesive is not used, since there is a risk of generating peeling-off at the time of molding, it is preferable that the metal sheet is coated with the adhesive and, then, integrally molded.

Next, the adhesive is explained.

As for such adhesives, an adhesive in which a polar group (such as maleic acid anhydride, acrylic acid, an epoxy group, or a hydroxyl group) is graft-polymerized to a side chain of a polyolefin-type resin to allow the polyolefin-type resin to be modified and, then, the thus-modified polyolefin-type resin is dissolved in an aromatic or aliphatic organic solvent to be in a liquid state or in a dispersion state, another adhesive in which styrene-butadiene rubber is dissolved in an aromatic or aliphatic solvent to be in a liquid state, or a mixture thereof is favorable. As for application methods of the adhesive, an optimal method may be selected from a dipping coating, a spray coating, a screen printing, a brushcoating, a stamping method and the like, as needed.

When an epoxy type or a cyanoacrylate type is used as the adhesive, integral molding can be performed but, after the integral molding, a sufficient adhesive strength can not be obtained such that the gasket is easily peeled off over the cover and, therefore, other adhesives than these adhesives may be used.

By favorably using the aforementioned thermoplastic elastomer composition, a specified gasket according to the embodiment of the present invention can be produced.

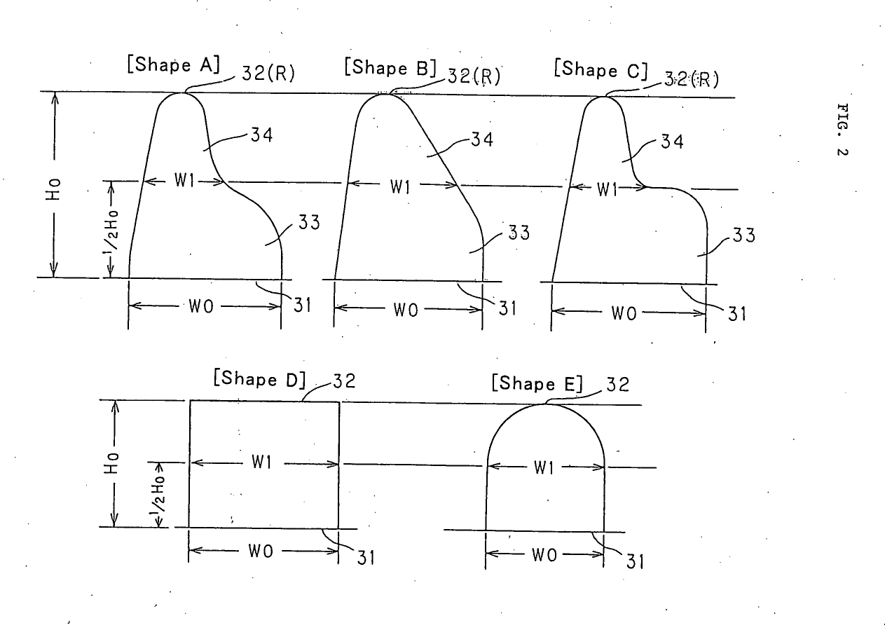

A cross-sectional shape of the gasket takes at least one of shapes A, Band C shown in FIG. 2. These gaskets have meaningfully excellent performance from the standpoint of sealability, water permeability, an adhesive property and the like. The term “cross-sectional shape” as used herein means a shape of a cross-section cut in a width direction of the gasket formed in rope form.

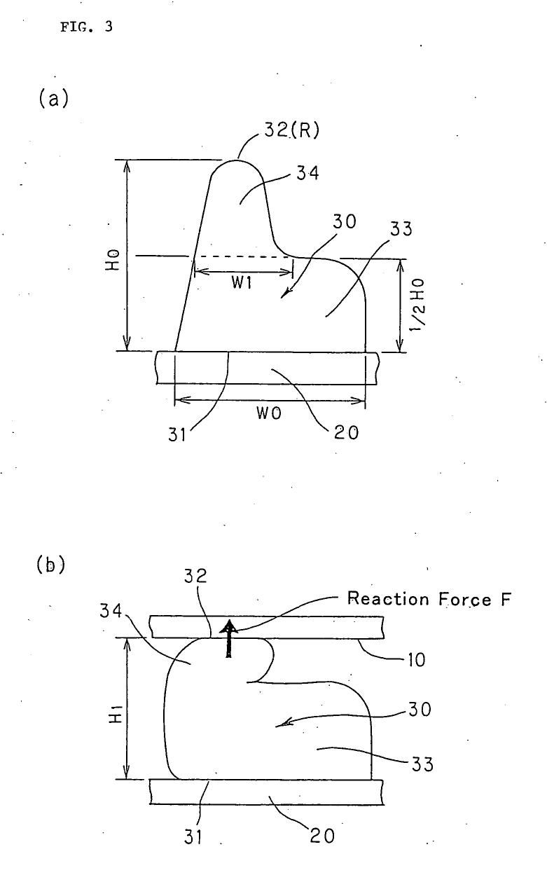

FIG. 3(a) shows a state in which the gasket having the shape C is integrally formed with a rear face of the cover 20. Further, FIG. 3(b) shows a state (state in use) in which a gasket sample having the shape C in a same manner as in the above is interposed between the cover 20 and the casing main body 10 to thereby seal a space between the two members 20 and 10.

As is shown in FIG. 3(a), in the gasket having the shape C, width W1 of an intermediate portion between a base portion 33 and a projection portion 34 is formed so as to be shorter than width W0 of an adhesion face against the rear face of the cover 20 and a tip end face 32 forms a curve having a specified curvature radius R. In a state in use (see FIG. 3(b)), the projection portion 34 is pressed against the casing main body 10 and compressed in a highly reproducible and comparatively constant shape and, accordingly, a large reaction force F against the casing main body 10 is generated. Therefore, a high sealability is secured between the two members 10 and 20 for a long period of time.

Further, inventors have confirmed that the gasket adopted the shape A or B performs a function in accordance with that in a case in which the shape C is adopted.

On this point, the inventors have exerted an intensive study and, as a result, found that, as a cross-sectional shape of the gasket in a width direction, length H0 in a direction in which the two members 10,20 face to each other and width W0 of an adhesion face against the cover 20 have a relation of “H0/W0≧0.8” therebetween and, further, as a cross-sectional shape of the gasket in the width direction, a base portion 33 arranged on the side of a rear face of the cover 20 and a projection portion 34 which is formed in a state projected from the base portion 33 and comprises a curved face (tip end face) 32 pointing toward a face of a periphery of an opening portion of the casing main body 10 are constituted and, still further, conditions in which a curvature radius R of the tip end face 32 is approximately 0.1 mm or more (preferably 0.2 mm or more), and a compression rate [100×(H0−H1)/H0] (%) of the gasket in use is approximately 20% or more are adopted along with the thermoplastic elastomer composition and, then, under these circumstances, meaningfully excellent performance in sealability, water permeability, moldability and the like can be obtained.

Further, in the aforementioned embodiment, a constitution in which the adhesion face of the gasket is arranged on the side of the cover is adopted but a constitution in which the adhesion face of the gasket is arranged on a face of a periphery of an opening portion of the casing main body may be adopted.

The gasket according to the present embodiment as described above prevents, particularly, vapor or dust from entering into electronic devices and, further, can favorably be used as a gasket for the hard disk drive in the field of a precision devices which require a low outgassing property and a high dust prevention property.

Particularly, it is favorably used for the hard disk drive having a high performance (high revolution), or the hard disk drive which is used in a high temperature environment as an in-vehicle article and the like.

Further, other than the aforementioned applications, the gasket can favorably be used in any of members which require air-tightness in various types of products as an ordinary gasket or packing.

### EXAMPLE

An embodiment according to the present invention will be described below.

Various types of samples were prepared by compositions shown in Table 1 and various types of evaluations were performed on the items described below.

Ethylene-propylene-nonconjugated Diene Ternary Copolymer Rubber
Sample A: EPDM (manufactured by Mitsui Chemical Co., Ltd.; trade name: EPT3045)

Crystalline Polyolefin Resin
Sample B: polypropylene-type resin (manufactured by Idemitsu Kosan Co., Ltd.; trade name: J700GP)

Softening Agent
Sample C: paraffin-type oil (manufactured by Idemitsu Kosan Co., Ltd.; trade name: Diana process oil PW380)

Organic Peroxide
Sample D: dicumyl peroxide (Nippon Oils & Fats Co., Ltd.; trade name: Percumyl D)

Adhesive
Modified olefin-type resin adhesive (manufactured by Mitsui Chemical Co., Ltd.; trade name: Unistol R120K)
   (Preparation of Sample)

A thermoplastic elastomer composition was obtained such that a predetermined amount of a compound as shown in Table 1 was measured and, then, subjected to mix-extrusion by a twin-screw extruder (manufactured by Kabushiki Kaisha Kobe Seikosho; Hiper KTX46) under conditions of a set temperature of from 180 to 210° C. and a revolving speed of 150 rpm.

The resultant material was treated by an injection molding machine (Kawaguchi Tekko K.K.; KM-80) under conditions of a set temperature of from 180 to 210° C., an injection speed of 0.5 second, an injection pressure of 100 MPa, and a cycle time of 30 seconds to thereby mold a test sheet (150×150×2 mm) which is, then, subjected to tests for hardness, compression set, an outgassing property, and water permeability.

Further, a member in which an adhesive was applied on an aluminum sheet (provided from 2 to 5 μm of electroless nickel plating: hereinafter referred to also as “cover”) which has previously been imparted with a cover shape (for example, a shape of the cover 20) was inserted into a metal mold and treated at an injection speed of 0.5 second, an injection output of 100 MPa, and a cycle time of 30 seconds to thereby form a gasket on a surface of the cover. The resultant cover-integrated gasket was put on a sealability test, an adhesive property test, and a moldability test.

(Cross-sectional Shape of Gasket Sample)

In FIG. 2, a cross-sectional shape of each of gasket samples applied to Examples 1 to 7, Comparative Examples 2, 3, and 5 to 7 described in Table 1 is shown. The term “cross-sectional shape” as used herein means a shape of a cross-section cut in a width direction of the gasket which is formed in rope form.

Being common to shapes A to E, a gasket (30) comprises a base end face 31 which is adhered to a rear face of a cover 20 and a tip end face 32 which is pressed against a face of a periphery of an opening portion of a casing main body 10. The gasket (30) is interposed between a rear face (surface of a first member) of a cover 20 and a face (surface of a second member) of the periphery of the opening portion of the casing main body 10 which face to each other and keeps an inside of a hard disk (casing) 1 in a hermetical state by sealing a space between the two members 10 and 20.

On this occasion, H0 means length of the gasket in the direction in which two members face to each other. Further, W0 means width W0 of an adhesion face against a surface of the first member. Still further, particularly, an entire shape of each of the shapes A to C is divided into a base portion 33 which is arranged on the side of a surface of the first member and a projection portion 34 which is arranged on the side of a surface of the second member. The projection portion 34 comprises a curved face (tip end face 32) pointing toward the surface of the second member and has a shape which is formed in such a state as projected from the base portion 33.

(Evaluation Method)

(1) Hardness

Three test sheets each having a thickness of 2 mm were put one on top of another and, then, measurements were conducted in accordance with JIS K6253.

(2) Compression Set Test

Compression set test was conducted in accordance with JIS K6262. Evaluation of the compression set after 168 hours at 100° C. was performed in accordance with the following evaluation criterion:

less than 50%: O

50% or more: ×

(3) Outgassing Property

A test piece of 50×3×2 mm in rectangular form was subjected to thermal extraction at 120° C. for one hour and a volume (μg/g) of the outgas was measured.

In this test, evaluation was performed in accordance with the following evaluation criterion:

Outgas volume: less than 50 (μg/g): O

Outgas volume: 50 (μg/g) or more: ×

In this occasion, the gasket in which the outgas volume shows 50 (μg/g) or more is not appropriate as a gasket for hard disk.

(4) Water Permeability Test

10 cc of distilled water was poured in an SUS container in cylindrical form (inner diameter: 27 mm; depth: 50 mm) and, then, a test piece which was adjusted to have a diameter of 30 mm and a thickness of 1 mm was interposed and, thereafter, fixed by a hollow cover (inner diameter of opening portion: 27 mm) made of SUS. Water permeability coefficient (g·mm/cm²·24 h) was determined from data after 100 hours at 70° C.

In this test, evaluation was performed in accordance with the following evaluation criterion:

Water permeability coefficient: less than 5×10⁻³ (g·mm/cm²·24 h): O

Water permeability coefficient: 5×10⁻³ or more (g·mm/cm²·24 h): ×

In this occasion, the sample in which the water permeability coefficient (g·mm/cm²·24 h) is 5×10⁻³ or more is not appropriate as a gasket for hard disk.

(5) Moldability Evaluation

In injection molding of the product, evaluation was performed in accordance with the following evaluation criterion:

Absence of defect: O

Presence of defect: ×

The term “defect” as used in this occasion means incapability of molding into a designated product shape, in which deformation, surface sink, surface defect, weld mark, shortshot, burr or the like is generated or a phenomenon in which a cover can not be integrally molded occurs.

(6) Evaluation of Sealability

A gasket which is integrally formed together with a cover is mounted on an actual machine-type leakage test device and subjected to a heating treatment at 80° C. for 168 hours and, then, cooled down to room temperature and, thereafter, exposed to a positive pressure of 5 kPa for 30 seconds from inside the test device and, then, after 15 seconds, was tested as to whether or not leakage is generated. In this test, evaluation was performed in accordance with the following evaluation criterion:

Absence of leakage: O

Presence of leakage: ×

In a case in which compression set of a gasket material is inferior or in another case in which there is a defect in a gasket shape, leakage is generated.

(7) Evaluation of Adhesive Property

A through-peeling of about 1 mm was formed on an adhesion face of a gasket which was integrally formed together with a cover and, then, a wire made of SUS was allowed to go through such peeled portion and, thereafter, a vertical tensile load was applied to the wire. When length of the peeled portion became 10 mm by expansion, the load (peeling load) was measured. In this test, evaluation was performed in accordance with the following evaluation criterion:

Peeling load: 100 (kPa) or more: O

Peeling load: less than 100 (kPa): ×

The gasket in which the peeling load shows 100 (kPa) or more assures a sufficiently high adhesive strength even in an actual application environment.

The test results are shown in Table 1.

TABLE 1

| Component of | | | | | | | | | | | | | | |
|---|---|---|---|---|---|---|---|---|---|---|---|---|---|---|
| thermoplastic | | | | | | | | | | | | | | |
| elastomer compound | Composition | | | | | | | | | | | | | |
| (content: part by | Example | | | | | | | Comparative Example | | | | | | |
| weight) | 1 | 2 | 3 | 4 | 5 | 6 | 7 | 1 | 2 | 3 | 4 | 5 | 6 | 7 |
| (1) Sample A (EPDM) | 100 | 100 | 100 | 100 | 100 | 100 | 100 | 100 | 100 | 100 | 100 | 100 | 100 | — |
| (2) Sample B (PP) | 25 | 25 | 25 | 40 | 15 | 25 | 25 | 5 | 160 | 25 | 25 | 25 | 25 | — |
| (3) Sample C | 100 | 80 | 60 | 100 | 20 | 100 | 100 | 100 | 100 | 10 | 10 | 100 | 100 | — |
| (softening agent) | | | | | | | | | | | | | | |
| (4) Sample D | 2 | 2 | 2 | 2 | 2 | 2 | 2 | 2 | 2 | 2 | 2 | 2 | 2 | — |
| (cross-linking | | | | | | | | | | | | | | |
| agent) | | | | | | | | | | | | | | |
| Cross-sectional | A | A | A | A | A | B | C | | A | A | | D | E | A |
| shape of gasket | | | | | | | | | | | | | | |
| R of projection | 0.2 | 0.2 | 0.2 | 0.2 | 0.2 | 0.25 | 0.17 | | 0.2 | 0.2 | | — | 1.0 | 0.2 |
| portion | | | | | | | | | | | | | | |
| H0/W0 | 1.12 | 1.12 | 1.12 | 1.12 | 1.12 | 1.12 | 1.12 | | 1.12 | 1.12 | | 0.8 | 1.0 | 1.12 |
| W1/W0 | 0.5 | 0.5 | 0.5 | 0.5 | 0.5 | 0.74 | 0.5 | | 0.5 | 0.5 | | 1.0 | 1.0 | 0.5 |
| (1) Hardness | 45 | 52 | 60 | 69 | 50 | 45 | 45 | | 93 | 85 | | 45 | 45 | 47 |
| (durometer type A) | | | | | | | | | | | | | | |
| (2) Compression set | ∘ | ∘ | ∘ | ∘ | ∘ | — | — | | x | x | | — | — | x |
| (3) Outgassing | ∘ | ∘ | ∘ | ∘ | ∘ | ∘ | ∘ | | ∘ | ∘ | | ∘ | ∘ | ∘ |
| property | | | | | | | | | | | | | | |
| (4) Water | ∘ | ∘ | ∘ | ∘ | ∘ | ∘ | ∘ | | ∘ | ∘ | | ∘ | ∘ | ∘ |
| permeability | | | | | | | | | | | | | | |
| (5) Moldability | ∘ | ∘ | ∘ | ∘ | ∘ | — | — | | ∘ | ∘ | | — | — | ∘ |
| (6) Sealability | ∘ | ∘ | ∘ | ∘ | ∘ | ∘ | ∘ | | x | x | | x | x | x |
| (7) Adhesive | ∘ | ∘ | ∘ | ∘ | ∘ | ∘ | ∘ | | ∘ | ∘ | | ∘ | ∘ | 47 |
| property | | | | | | | | | | | | | | |

* As Comparative Example 7, a styrene-type thermoplastic elastomer [ELASTOMER-AR-540; manufactured by ARONKASEI CO., LTD.] was used.

As described above, the thermoplastic elastomer composition having a constitution as shown in the present embodiment has excellent characteristics in sealability, an outgassing property, water permeability, an adhesive property, moldability for a long period of time under a high temperature and is capable of being constructed as a cover-integrally-molded gasket having an extremely admirable performance. On the other hand, gaskets produced under such conditions as shown in Comparative Examples have a drawback in at least one of the above-described performances required for a gasket for hard disk drive.

### INDUSTRIAL APPLICABILITY

As is described above, by using the gasket according to the present invention, it becomes possible to intend to enhance qualities such as sealability, an outgassing property, water permeability, an adhesive property, and mold ability for long period of time under a high temperature. Further, in the molded gasket, it is possible to simplify the production process.

1-7. (canceled)

8. A thermoplastic elastomer composition, comprising an ethylene-propylene-nonconjugated diene ternary copolymer or an ethylene-propylene binary copolymer, a crystalline polyolefin resin, a non-aromatic softening agent, and an organic peroxide, wherein the crystalline polyolefin resin has from 0.1 g/10 min. to 100 g/10 min. of melt flow rate which is measured in accordance with JIS K7210 under conditions of 230° C. and 21.18 N and is contained in an amount of from 10 to 150 parts by weight every 100 parts by weight of the copolymer;
the non-aromatic softening agent has a kinetic viscosity of 300 mm²/S or more at 40° C. and is contained in an amount of from 20 to 150 parts by weight every 100 parts by weight of the copolymer;
the organic peroxide is contained in an amount of from 0.1 to 10 parts by weight every 100 parts by weight of the copolymer; and
hardness measured by a JIS type A durometer is from 30 to 70 degrees.

9. The thermoplastic elastomer composition as set forth in claim 8, wherein the crystalline polyolefin resin is contained in an amount of 100 parts by weight every 100 parts by weight of the copolymer.

10. The thermoplastic elastomer composition as set forth in claim 8, wherein compression set measured in accordance with JIS K6262 after 168 hours of standing time at 100° C. is 50% or less.

11. The thermoplastic elastomer composition as set forth in claim 9, wherein compression set measured in accordance with JIS K6262 after 168 hours of standing time at 100° C. is 50% or less.

12. The gasket, which is formed by using the thermoplastic elastomer composition as set forth in claim 8 as a material.

13. The molded gasket constituting a cover member, wherein the thermoplastic elastomer composition as set forth in claim 8 is integrally molded together with a metal sheet as a gasket.

14. The sealing structure between two members constituted such that a metal surface of one member and a surface of the other member face to each other while interposing a gasket therebetween, wherein the sealing structure between two members is constituted such that the gasket which is formed by injection molding the thermoplastic elastomer composition as set forth in claim 8 on a metal surface of one member coated with an adhesive is pressed against a surface of the other member.

15. A gasket, which is interposed between a surface of a first member and a surface of a second member which face to each other and is adhered to the surface of the first member such that it seals a space between the two members, wherein, as a cross-sectional shape of the gasket in a width direction, length H0 in a direction in which the two members face to each other and width W0 of an adhesion face against the surface of the first member have a relation of “H0/W0≧0.8” therebetween and, further, as a cross-sectional shape of the gasket in the width direction, a base portion arranged on the side of the surface of the first member and a projection portion which is formed in a state projected from the base portion and comprises a tip end of a curved face pointing toward the surface of the second member are provided and, still further, a curvature radius R of the tip end of the curved face is 0.1 mm or more.
